(19) United States
(12) Patent Application Publication
(10) Pub. No.: US 2015/0340899 A1
(43) Pub. Date: Nov. 26, 2015

(54) AUTOMATIC BATTERY DISCHARGE TOOL

(71) Applicant: FORD GLOBAL TECHNOLOGIES, LLC, DEARBORN, MI (US)

(72) Inventors: John P. Bilezikjian, Canton, MI (US); Thomas J. Coupar, Ann Arbor, MI (US); James J. Gibbons, Milford, MI (US)

(73) Assignee: FORD GLOBAL TECHNOLOGIES, LLC, DEARBORN, MI (US)

(21) Appl. No.: 14/281,941

(22) Filed: May 20, 2014

(51) Int. Cl. H02J 7/00

(52) U.S. Cl. CPC H02J 7/0063

(57) ABSTRACT

An assembly for discharging a battery using an adjustable variable resistor. A battery is connected to the assembly. An operating sequence for the connected battery is selected from a plurality of predetermined operating sequences for different batteries. The predetermined operating sequences are presented as a function of a battery characteristic. The selected operating sequence adjusts the resistor and the battery is discharged using the adjusted resistor.

### BACKGROUND OF INVENTION

The present invention relates to an assembly for discharging a battery and in particular to an assembly for automating the discharging process.

A high voltage battery may need to be discharged prior to transporting or storing the battery. The battery may be discharged using a decade box. The decade box includes a plurality of resistors of different values which may be configured to provide a specific resistance.

However, using the decade box to discharge a specific battery requires an operator to correctly configure the decade box to match the resistance to a voltage of the specific battery. Operation of the decade box to discharge the battery may include reconfiguring the decade box to provide different resistances as the voltage of the battery is discharged.

### SUMMARY OF INVENTION

An embodiment contemplates a method of discharging a battery. A charged battery is connected to a variable resistor. A constant load value is selected to achieve a desired state of charge of the battery. The resistor is automatically adjusted with a controller to provide the selected load. The adjusted resistor is used to discharge the battery.

Another embodiment contemplates a method of discharging a battery. A charged battery is connected to a variable resistor. An operating sequence is selected for the resistor to achieve a desired state of charge of the battery. The sequence is selected by an operator from a plurality of predetermined sequences. The battery is discharged using the resistor while a controller automatically adjusts resistance of the resistor as a function of the sequence.

Another embodiment contemplates a battery discharging assembly comprising an adjustable variable resistor, battery positive and negative terminals, a user input apparatus, and a controller. The battery terminals are connected to the resistor. The user input apparatus has a plurality of predetermined operating sequences that are a function of a battery characteristic. The controller is configured to adjust resistance of the resistor, per the sequence selected via the input apparatus, to achieve a desired state of charge of the battery.

An advantage of an embodiment is that the battery discharging assembly automates discharging a high voltage battery. This will reduce the time required for an operator to monitor discharging the battery.

### BRIEF DESCRIPTION OF DRAWINGS

FIG. 1 is a schematic view of a battery discharging assembly.

FIG. 2 is a flow chart of a battery discharging method.

FIG. 3 is a graph of a battery discharging method.

FIG. 4 is a graph of a battery discharging method.

### DETAILED DESCRIPTION

FIG. 1 schematically illustrates a battery discharging assembly 10. The assembly 10 includes a case 12, a plurality of adjustable variable resistors 14, a controller 16, and first and second battery terminals 18 and 20, respectively. The resistors 14 are connected to the controller 16. Individual resistors 14 are turned on or off by controller 16 to vary the total resistance of the assembly 10. The first and second battery terminals 18 and 20, respectively, connect a battery 22 to the assembly 10. The first and second battery terminals 18 and 20, respectively, are able to connect a plurality of different batteries to the assembly 10.

An operator uses a user input apparatus 24 to select an operating sequence for the assembly 10. The operating sequences match resistance of the assembly 10 to different batteries 22 that are connectable to the assembly 10. The user input 24 is any suitable means known to one skilled in the art for the operator to interface with the controller 16. For example, the user input 24 may be a touch screen display or a keypad.

The user input 24 may present a predetermined plurality of operating sequences for the operator to choose from, arranged by a characteristic of the battery 22. For example, the operating sequences may be listed by a charge capacity of the battery 22, a car model using the battery 22, or application for the battery 22 (e.g., hybrid electric vehicle, partial hybrid electric vehicle, battery electric vehicle). Alternatively, the operator may input the battery characteristic via the user input 24 and the controller 16 matches the inputted battery characteristic to the appropriate operating sequence or calculates the appropriate operating sequence. Alternatively, the operating sequence may be selected by the controller 16, without input from the operator, after the controller 16 detects the battery characteristic. The selected operating sequence is communicated by the user input 24 to the controller 16. The controller 16 in turn uses the selected operating sequence to turn on or off individual resistors 14 to match the resistors 14 to the connected battery 22. The battery 22 is discharged by the assembly 10 applying the matched resistor 14 across the battery 22.

The assembly 10 also includes a shorting bar 26. The shorting bar 26 is connected to the battery 22 to prevent voltage rebound after the battery 22 is discharged but still connected to the assembly 10. The shorting bar 26 may be grounded to the case 12. The shorting bar 26 may be connected by the controller 16 to the battery 22 via a switch 28.

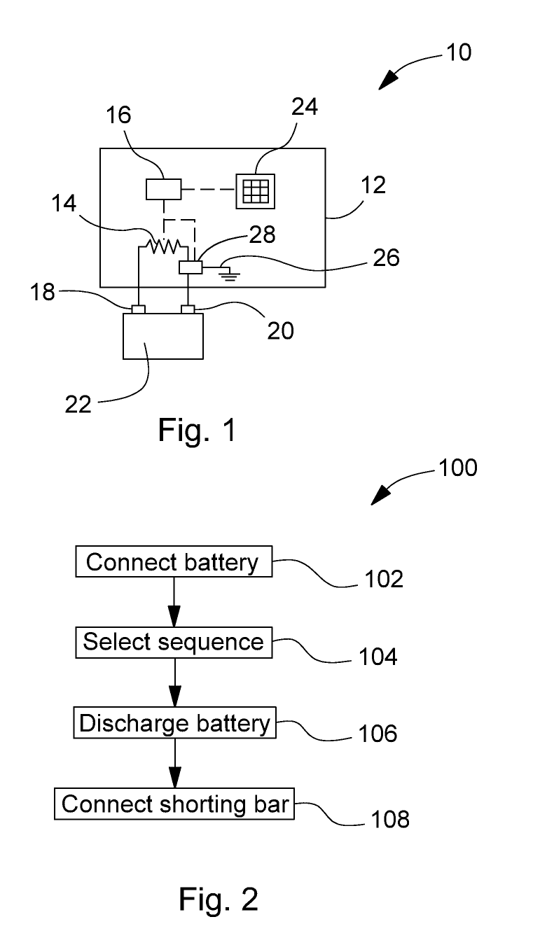

FIG. 2 will now be discussed with reference to FIG. 1. FIG. 2 illustrates an operating routine 100 for the battery discharging assembly 10. In a step 102, the battery 22 is connected to the assembly 10 via the first and second battery terminals 18 and 20, respectively. Next, in a step 104, the operating sequence is selected. As discussed, the operating sequence may be selected by the operator from the plurality of operating sequences presented by the user input 24, inputted by the operator to the user input 24 by the operator, or automatically detected and selected by the controller 16. In a step 106 the battery 22 is discharged by the resistor 14 as discussed and in a step 108 the shorting bar 26 is connected to the discharged battery 22.

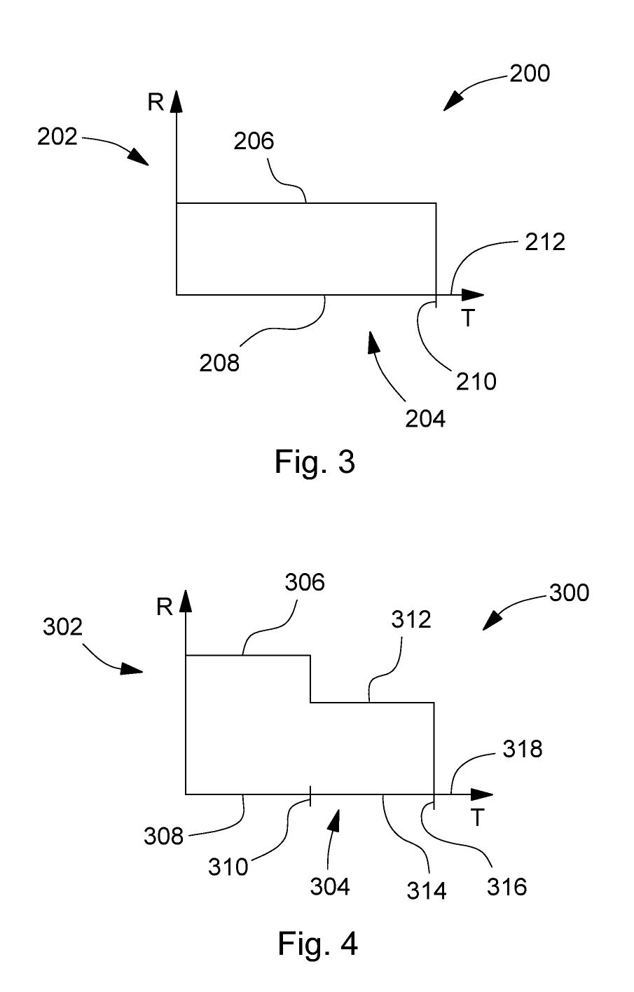

FIG. 3 will now be discussed with reference to FIG. 1. FIG. 3 illustrates a step function 200 for discharging a first battery 22 in accordance with a first operating sequence. The resistor 14 is set at a resistance 202, which is a function of a time 204. Per the first selected operating sequence, the controller 16 sets the resistor 14 to a constant first resistance 206 for a first time duration 208. After a time point 210, the controller 16 sets the resistor 14 to a constant second resistance 212, the second resistance 212 being equal to zero resistance. The first time duration 208 is calculated to discharge the first battery 22 to a desired state of charge.

FIG. 4 will now be discussed with reference to FIG. 1. FIG. 4 illustrates a step function 300 for discharging a second battery 22 in accordance with a second operating sequence. The resistor 14 is set at a resistance 302, which is a function of a time 304. Per the second selected operating sequence, the controller 16 sets the resistor 14 to a constant first resistance 306 for a first time duration 308. After a first time point 310, the controller sets the resistor 14 to a constant second resistance 312 during a second time period 314. After a second time point 316, the controller 16 sets the resistor 14 to a constant third resistance 318, the third resistance 318 being equal to zero resistance. The first and second time periods 308 and 314, respectively, are calculated to discharge the second battery 22 to a desired state of charge. The second resistance 312 is less than the first resistance 306 to correspond to the predicted lesser voltage during the second time period 314 than the first time period 308.

While certain embodiments of the present invention have been described in detail, those familiar with the art to which this invention relates will recognize various alternative designs and embodiments for practicing the invention as defined by the following claims.

1. A method of discharging a battery comprising the steps of:
connecting the battery to a variable resistor;
automatically adjusting the resistor with a controller to provide a constant load value that achieves a desired state of charge of the battery;
discharging the battery using the adjusted resistor.

2. The method of claim 1 comprising the further step of connecting a shorting bar to the discharged battery.

3. The method of claim 1 wherein the load value is selected by an operator from a plurality of predetermined load values.

4. The method of claim 3 wherein the plurality of predetermined load values are a function of a battery characteristic.

5. The method of claim 4 wherein the battery characteristic is a battery charge capacity.

6. The method of claim 1 wherein, after the resistor is adjusted to provide the selected load value, resistance of the resistor is kept constant until the battery is discharged to the desired state of charge.

7. A method of discharging a battery comprising the steps of:
connecting the battery to a variable resistor;
discharging the battery using the resistor while a controller automatically adjusts resistance of the resistor as a function of an operating sequence for the resistor to achieve a desired state of charge of the battery, wherein the sequence is selected from a plurality of predetermined sequences.

8. The method of claim 7 comprising the further step of connecting a shorting bar to the discharged battery.

9. The method of claim 7 wherein resistance of the resistor is varied as a decreasing step function of time during battery discharging.

10. The method of claim 7 wherein the plurality of predetermined sequences are a function of a battery characteristic.

11. The method of claim 10 wherein the battery characteristic is a battery charge capacity.

12. A battery discharging assembly comprising:
an adjustable variable resistor;
battery positive and negative terminals connected to the resistor;
a user input apparatus having a plurality of predetermined operating sequences as a function of a battery characteristic;
a controller configured to adjust resistance of the resistor per the sequence selected via the input apparatus to achieve a desired state of charge of the battery.

13. The assembly of claim 12 further comprising a battery shorting bar grounded to the assembly.

14. The assembly of claim 12 wherein the controller is configured such that, after being adjusted per the sequence, resistance of the resistor is kept constant until the battery is discharged to the desired state of charge.

15. The assembly of claim 12 wherein the controller is configured such that resistance of the resistor is decreased as a step function during battery discharging.

16. The assembly of claim 15 wherein the step function is a function of time.

17. The assembly of claim 12 wherein the battery characteristic is a battery charge capacity.
